(19) United States
(12) Patent Application Publication
(10) Pub. No.: US 2008/0067839 A1
(43) Pub. Date: Mar. 20, 2008

(54) Wind Deflector

(75) Inventor: Thomas Staltmayer, Gauting (DE)

Correspondence Address: ROBERTS, MLOTKOWSKI & HOBBES, P. O. BOX 10064, MCLEAN, VA, 22102-8064, US

(73) Assignee: WEBASTO AG, STOCKDORF (DE)

(21) Appl. No.: 11/571,286

(22) PCT Filed: Jun. 17, 2005
(86) PCT No.: PCT/EP05/06536

§ 371 Date: Oct. 5, 2007

(30) Foreign Application Priority Data
Jun. 25, 2004 (DE) 10 2004 030 804.7

(51) Int. Cl. B60J 7/22

(52) U.S. Cl. 296/217

(57) ABSTRACT

A wind deflector for an openable vehicle roof with a movable cover element has a raisable deflector element (20) made of a flexible flat material and at least two lateral raising arms (22), each of which, with its end facing the vehicle rear, is coupled in the region of the roof-mounted guide rail (14) and is used for moving the deflector element (20) between the lowered rest position and a raised, at least partially tensioned operating position. The raising arms (22) are each provided with a retraction means (28) so that the coupling points are pushed in the direction of the vehicle rear in the operating position as compared to their location in the rest position, and the positioning angle of the deflector element (20) undergoes a reduction during raising.

### BACKGROUND OF THE INVENTION

1. Field of the Invention

The invention relates to a wind deflector for an openable vehicle roof with a raisable deflector element that is made of a flexible flat material and at least two lateral raising arms, each of which, on its end facing the vehicle rear, is provided with a coupling point located in the region of the roof-mounted guide rail and is used for moving the deflector element between a lowered rest position and a raised, at least partially tensioned, operating position.

2. Description of Related Art

Such a wind deflector is known from practice and is made as a so-called net wind deflector in which a raisable deflector element is formed from a fine-mesh net and which is used especially in large glass sliding roofs. The net is connected to the vehicle roof, on the one hand, in the region of the front edge area of the roof opening, and on the other, to an essentially U-shaped bracket with two free legs each of which forms a so-called raising arm. The end of each raising arm that is directed toward the rear of the vehicle is pivotally coupled in the area of the roof-mounted guide rail. The raising arms are used to set the deflector element between the lowered rest position and a raised, at least partially tensioned, operating position. The actuation of the raising arms which are generally pretensioned in the raising direction by a tensioning means takes place by means of the cover element of the sliding roof such that, when the vehicle roof is opened, they are released by the cover element which adjoins the raising arms with the roof closed, so that they automatically execute a raising motion. When the sliding roof is closed, the cover element runs against the top of the raising arms so that they are pivoted down into the rest position and the deflector element is folded in. However, for the described net wind deflector, there is the problem that the deflector element made as a net has a very steep or almost vertical positioning angle in the operating position; this has an adverse effect with respect to the development of noise which occurs when the vehicle is driving.

Moving the coupling points of the raising arms of a net wind deflector in the direction of the rear of the vehicle was also tested. This does lead to a flatter positioning angle of the raised deflector element. However, this causes the lowered deflector element to be in the field of vision of the passenger or passengers when the cover element is closed, which is undesirable.

German Patent DE 100 46 455 C1 discloses a wind deflector of an openable vehicle roof which comprises a deflector element formed from a flexible film. The film can be moved into the operating position by means of raising arms. The rear end of each of the raising arms has a slot in which a roof-mounted pivot is guided, around the axis of which the respective raising arm can be pivoted. When the wind deflector is lowered, the raising arms are moved in the direction of the vehicle rear.

Furthermore, German Patent DE 102 48 864 B3 discloses a wind deflector for an openable vehicle roof which has a raisable wind deflector leaf which is attached to the lateral raising arms. The rear ends of the raising arms are supported on a pivoting axis which is movably supported in the region of roof-mounted guide rails and can be moved to the rear via a pin-link path arrangement during lowering. The link path has the shape of a curve with an apex to the rear. Thus, low-wear actuation and space-saving accommodation of the wind deflector can be achieved.

### SUMMARY OF THE INVENTION

The object of the invention is to devise a wind deflector of the initially mentioned type which is optimized relative to the prior art with respect to the resulting driving noise.

This object is achieved in accordance with the invention by a wind deflector in which the raising arms are each provided with a retraction means so that the coupling points are pushed in the direction of the vehicle rear in the operating position as compared to their location in the rest position and the positioning angle of the deflector element undergoes a reduction during raising.

The heart of the invention, therefore, lies in that a translational motion is forced on the raising arms in addition to a pivoting motion. The mounting of the raising arms, therefore, is not fixed relative to the roof. Rather, the coupling points of the raising arms can be changed. On the one hand, the optimized position of the raising arms for the rest position of the deflector element, and on the other, a noise-optimized and operation-optimized positioning angle of the deflector element can be chosen by the offset of the raising arms in the direction of the vehicle rear which takes place by a retraction means when the flexible raising element is raised. The positioning angle of the deflector element is dependent on the amount of offset of the raising arms during their pivoting motion.

Basically, the raisable deflector element can be made of any flexible, flat material. In particular, however, the wind deflector in accordance with the invention is also suited for use with a deflector element which is made as a fine-mesh net and which can be installed, for example, for large glass roofs or the like. However, it is also possible to produce the deflector element from a metal, plastic or composite film.

Actuation of the raising arms of the wind deflector in accordance with the invention takes place, advantageously, by means of the cover element of the openable vehicle roof. The cover element interacts with the top of the raising arms such that, with the roof closed, it blocks the raising of the deflector element and with the roof opened, it releases the raising arms which are preferably pretensioned in the raising direction. When the roof is closed, the cover element runs against the raising arms so that they are pivoted again into their lowered rest position.

The raising arms of the wind deflector in accordance with the invention can be a component of an essentially U-shaped, integrally manufactured carrier for the deflector element. Of course, it is also possible for the raising arms to be separate components which hold the deflector element, if necessary, only in lateral edge areas. A connection between the two laterally arranged raising arms is then, optionally, not necessary.

In a preferred embodiment of the wind deflector in accordance with the invention, the retraction means assigned to each of the raising arms is formed by a mechanical forced control which imparts a linear translational motion to the respective raising arm in the direction of the vehicle rear for pivoting-out, and a linear translational motion in the direction of the vehicle front for pivoting-in. Alternatively, it is of course also possible to actuate the retraction means by a motor.

In a special embodiment of the wind deflector in accordance with the invention, the retraction means formed as mechanical forced control comprises a lever which is coupled at one end in the middle region of the respective raising arm and with its other end is coupled so as to be roof-mounted. The raising arms, which have a variable coupling point on their back ends in the area of a roof-mounted guide rail, undergo an offset in the direction of the vehicle rear by the respectively assigned lever in the course of its raising motion.

In an alternative embodiment of the wind deflector in accordance with the invention, the retraction means comprises a link path. When the link path is roof-mounted, it is used to guide a guide element made on the respective raising arm, especially a pivot, so that the raising arm is forced in the direction of the vehicle rear in the course of its raising motion. Alternatively, a respective link path can also be formed on the raising arms and acted upon by the roof-mounted guide element.

Advantageously, a respective guide means is provided for each of the raising arms of the wind deflector in accordance with the invention for guidance along the respective roof-mounted guide rail. This ensures that the coupling point of the respective raising arm always has a defined position. The guide means is implemented, for example, by an essentially horizontally aligned slot which is engaged by a guide element, such as a pin, which is connected to the respective raising arm.

Other advantages and advantageous embodiments of the subject matter of the invention will become apparent from the following description in conjunction with the accompanying drawings.

### BRIEF DESCRIPTION OF THE DRAWINGS

FIG. 1 is a perspective view of the outer side of a left partial region of a wind deflector with a retraction means in the lowered state;

FIG. 2 is a view corresponding to that of FIG. 1, but showing the wind deflector in the raised state;

FIG. 3 is a perspective view of the inner side of the region shown in FIG. 2; and

FIG. 4 is a perspective view of the outer side of a region of the wind deflector which comprises the retraction means.

### DETAILED DESCRIPTION OF THE INVENTION

The drawings show a wind deflector 10 which is located in the region of the front edge of the roof opening 12 of a motor vehicle which is not otherwise illustrated. The roof opening 12 can be alternately closed or at least partially opened by means of a cover element which is not shown here for the sake of clarity.

The wind deflector 10 is mirror-symmetrical with respect to the lengthwise center plane of the vehicle and is therefore explained below only using its left partial region.

To guide the cover element, the roof opening 12 is bordered on either side by a guide rail 14 which is a component of the roof frame. In the front region of the guide rails 14, a respective base 16 is formed which is a component of the wind deflector 10 and is used to support an essentially U-shaped carrier profile 18 which connects the two guide rails 14 to one another and on which a raisable deflector element 20 is suspended which made of a fine-mesh net and is fixed to the roof on its edge facing away from the carrier profile 18.

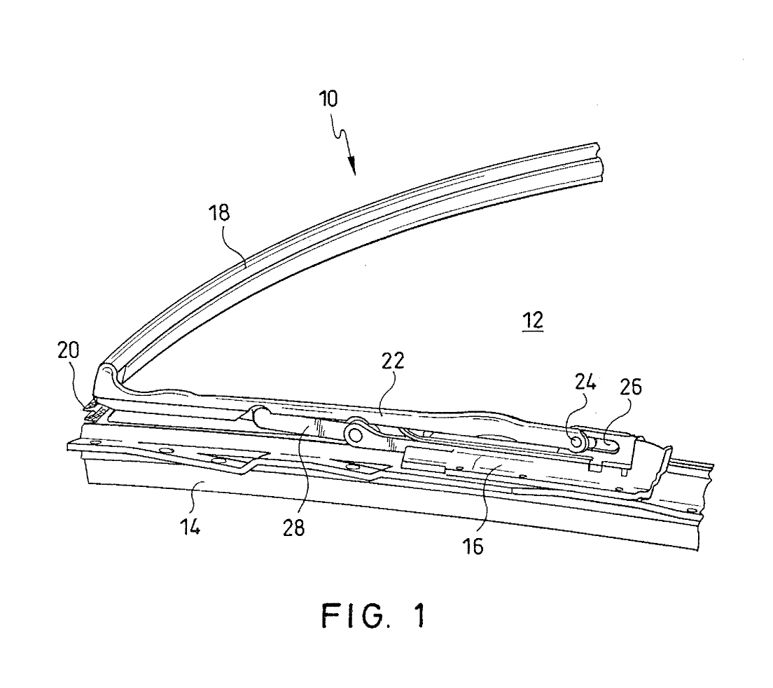

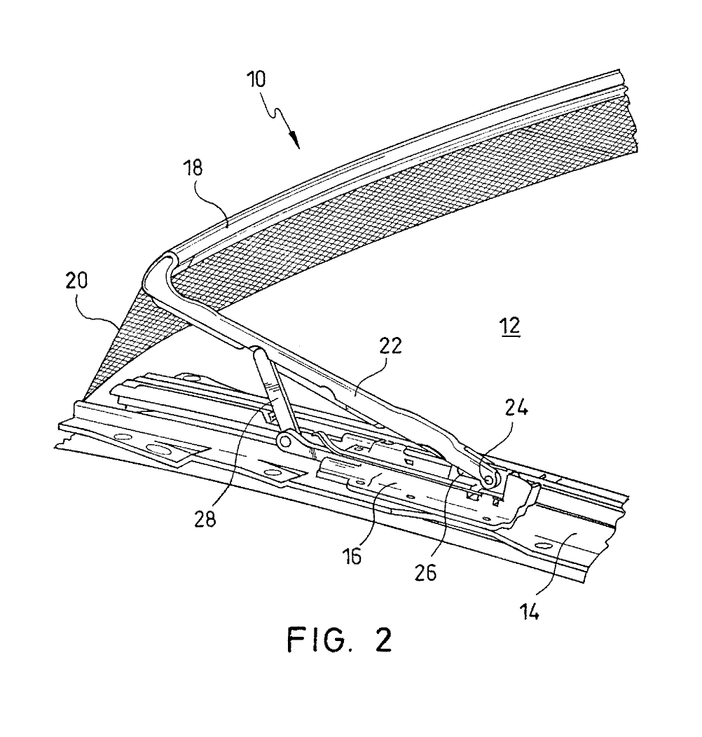

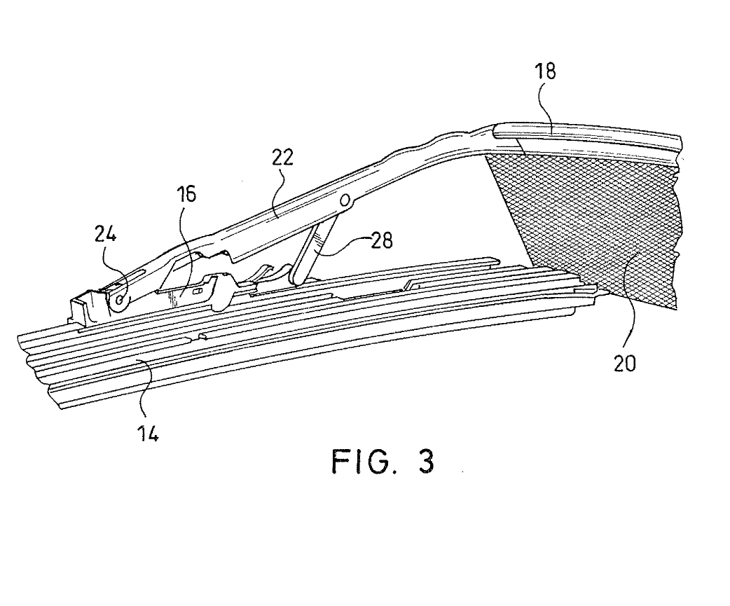

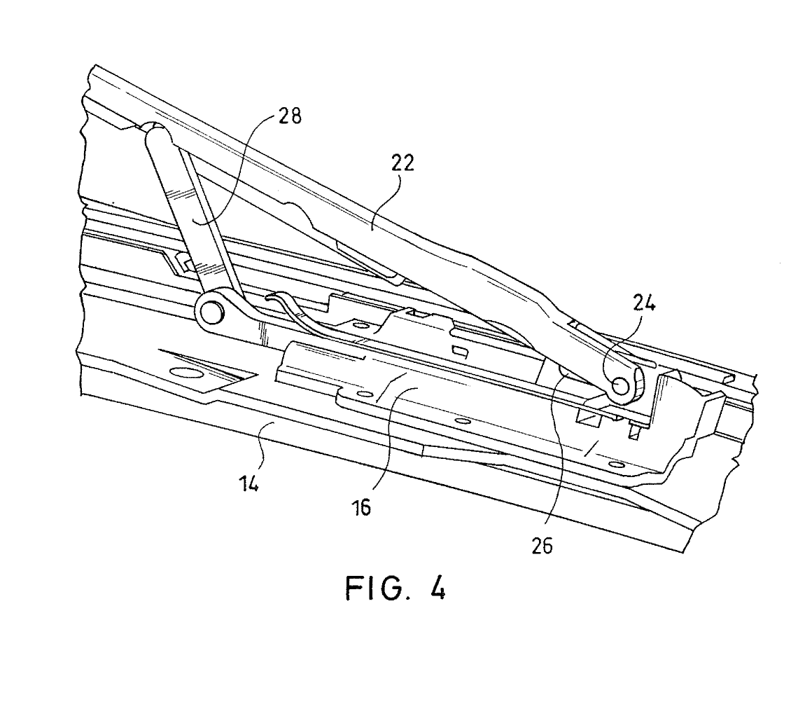

The free legs of the U-shaped carrier profile 18 are each made as a raising arm 22 which, on its end facing the vehicle rear, is movably supported via a pin 24 in a slot 26 which is arranged essentially horizontally and which is formed on the base 16. The raising arms 22 are used to move the deflector element 20 between the lowered rest position shown in FIG. 1 and a raised operating position which is shown in FIGS. 2 to 4 and in which the deflector element 20 is tensioned. The raising arms 22 are each pretensioned toward the raised position by a pretensioning means which is made, for example, as a leaf spring or the like.

Furthermore, a retraction means 28 is assigned to each raising arm 22 of the wind deflector 10. The retraction means 28 is formed by a lever or connecting rod which is pivotally mounted at one end on the base 16 and at its other end in the middle region of the raising arm 22.

The raising of the wind deflector 10 and moving it into position take place in the manner described below. The starting point is the rest position which is shown in FIG. 1 and in which the wind deflector 10 is held down by means of the cover element of the sliding roof (not shown). In this connection, the cover element adjoins the two raising arms 22. When the sliding roof is pulled back, the raising arms 22, based on their pretensioning in the raising direction, undergo a raising movement. During the raising motion, the raising arms 22 are pivoted around the axis of the respective pin 24. At the same time, the respective lever 28 is raised which causes the respective raising arm 22 to be offset in the direction of the vehicle rear.

The maximum offset of the raising arms 22 is fixed by the length of the respectively assigned slot 26 in which the respective pin 24 is moved in the course of the raising motion of the raising arm 22. The positioning angle of the deflector element 20 made as a net can be adapted to be optimized in terms of noise and operation by the action of the retraction means.

When the cover element is closed, the cover runs against the raising arms 22 so that the raising arms 22 are pivoted against the action of the respective pretensioning means back into their rest position shown in FIG. 1.

1-9. (canceled)

10. Wind deflector for an openable vehicle roof with a movable cover element, comprising:
a roof-mounted guide rail,
a raisable deflector element made of a flexible flat material,
at least two lateral raising arms for moving the deflector element between a lowered rest position and a raised, at least partially tensioned operating position, each of which is coupled to the raisable deflector element at a front end thereof and is coupled to the roof-mounted guide rail at coupling points located at a rear end thereof, and
a respective retraction means for pushing each of the coupling points in a rearward direction away from the deflector element during movement of the deflector element from rest position to the operating position so as lower the angle of inclination of the deflector element during raising.

11. Wind deflector in accordance with claim 10, wherein the retraction means comprises a mechanical forced control which imparts a linear translational motion to the respective raising arm.

12. Wind deflector in accordance with claim 10, wherein the retraction means comprises a lever which is coupled at one end in a middle region of the respective raising arm and is connected to the guide rail at an opposite end.

13. Wind deflector in accordance with claim 10, wherein the retraction means comprises a link path.

14. Wind deflector in accordance with claim 10, wherein a respective guide means for guiding the raising arms along the respective roof-mounted guide rail is connected to the raising arms.

15. Wind deflector in accordance with claim 14, wherein the respective guide means comprises an essentially horizontally aligned slot in which a guide element of the respective raising arm is guided.

16. Wind deflector in accordance with claim 10, wherein the flexible, flat material of the deflector element is a fine-mesh net.

17. Wind deflector in accordance with claim 10, wherein the raising arms are pretensioned in a raising direction.

18. Wind deflector in accordance with claim 10, wherein the raising arms are a component of an essentially U-shaped carrier for the deflector element.
